(19) United States
(12) Patent Application Publication
(10) Pub. No.: US 2011/0235829 A1
(43) Pub. Date: Sep. 29, 2011

(54) DIAPHRAGM AND SILICON CONDENSER MICROPHONE USING SAME

(76) Inventors: Bin YANG, Shenzhen (CN); Rui Zhang, Shenzhen (CN)

(21) Appl. No.: 12/978,574

(22) Filed: Dec. 26, 2010

(30) Foreign Application Priority Data
Mar. 29, 2010 (CN) 201010137951.5

(51) Int. Cl. H04R 11/04; H04R 7/00

(52) U.S. Cl. 381/174; 181/157

(57) ABSTRACT

Disclosed is a diaphragm includes a vibrating member, a plurality of supporting members extending from a periphery of the vibrating member along a direction away from a center of the diaphragm, and a plurality of separating portions each located between two adjacent supporting members. Each of the supporting members defines a first beam, a second beam, and at least one slit between the first and second beams.

### FIELD OF THE INVENTION

The present invention relates to MEMS (micro-electro-mechanical system) components, and more particularly, to a silicon condenser microphone having a diaphragm.

### DESCRIPTION OF RELATED ART

Silicon condenser microphones are widely used in mobile phones to receive and convert sound waves into electrical signals. A silicon condenser microphone related to the present invention comprises a silicon substrate, a diaphragm arranged on the substrate and a backplate parallel and opposed from the diaphragm for forming a capacitor. The diaphragm is generally the type of one-piece and the entire periphery of the diaphragm is fixed on the substrate.

However, the related silicon condenser microphone increases the restriction at the periphery of the vibrating diaphragm. In addition, when the diaphragm vibrates, a parasitic capacitor will occur between the diaphragm and the silicon substrate.

So, it is necessary to provide a new means for solving the problems mentioned above.

### BRIEF DESCRIPTION OF THE DRAWINGS

FIG. 1 is an illustrative cross-sectional view of a silicon condenser microphone in accordance with an exemplary embodiment of the present invention; and

FIG. 2 is an illustration of a diaphragm of the silicon condenser microphone in FIG. 1.

### DETAILED DESCRIPTION OF THE EMBODIMENT

Reference will now be made to describe the exemplary embodiment of the present invention in detail.

An exemplary embodiment of the present invention provides a silicon condenser microphone used in a mobile phone for converting sound waves into electrical signals.

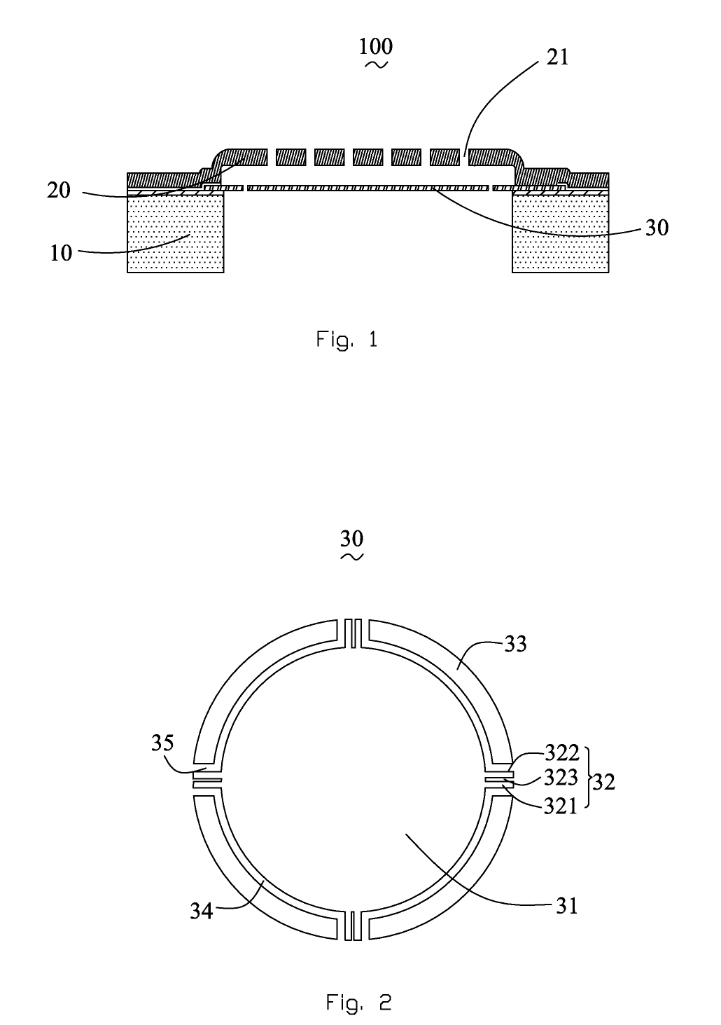

Referring to FIG. 1, a silicon condenser microphone 100 of the exemplary embodiment includes a substrate 10, a diaphragm 30 anchored to the substrate 10, and a backplate 20 opposed from the diaphragm 30. The backplate 20 defines a plurality of perforations 21 therethrough. The diaphragm 30 and the backplate 20 are respectively provided with an electrode (not shown) for cooperatively forming a capacitor. While the diaphragm 30 is activated to vibrate by the sound pressure of the sound waves, a distance between the diaphragm 30 and the backplate 20 is changed and the capacitance value of the capacitor is accordingly changed, which converts the sound waves into electrical signals.

Referring to FIG. 2, the diaphragm 30 of the silicon condenser microphone 100 defines a vibrating member 31, a plurality of supporting members 32 radially extending from a periphery of the vibrating member 31 along a direction away from a center of the diaphragm 30, and a plurality of separating portions 33 for reducing parasitic capacitance between the diaphragm 30 and the substrate 10. Each of the separating portions 33 locates between two adjacent supporting members 32. A first gap 34 is formed between the vibrating member 31 and the separating portions 33 and a second gap 35 is formed between the separating portion 33 and an adjacent supporting member 32. The first gap 34 is communicated with the second gap 35 and preferably, a width of the first gap 34 is same to that of the second gap 35.

The vibrating member 31 is circular. The periphery of the vibrating member 31 is divided into a plurality of equal parts by the supporting members 32.

Each supporting member 32 defines a first beam 321, a second beam 322, and at least one slit 323 between the first and second beams. The slit 323 of each supporting members 32 extends from one end of the supporting member 32 far from the periphery of the vibrating member 31 to another end of the supporting member 32 near the periphery of the vibrating member 31. The separating portion 33 is symmetrical and concentric with respect to the center of the vibrating member 31.

In summary, the diaphragm is two-piece type and the vibrating member is connected with the substrate by the supporting members, thereby reducing restriction at the periphery of the vibration diaphragm. Moreover, each supporting member defines at least one slit, thereby preventing the deflection of the diaphragm, so that the product sensitivity can be effectively improved.

While the present invention has been described with reference to the specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A diaphragm, comprising:
a vibrating member;
a plurality of supporting members extending from a periphery of the vibrating member along a direction away from a center of the diaphragm;
a plurality of separating portions each located between two adjacent supporting members;
wherein, each of the supporting members defines a first beam, a second beam, and at least one slit between the first and second beams.

2. The diaphragm as described in claim 1, wherein the slit extending from one end of the supporting member far from the periphery of the vibrating member to another end of the supporting member near the periphery of the vibrating member.

3. The diaphragm as described in claim 1, wherein a first gap is formed between the vibrating member and the separating portions and a second gap is formed between the separating portion and an adjacent supporting member.

4. The diaphragm as described in claim 3, wherein the periphery of the vibrating member is divided into a plurality of equal parts by the supporting members.

5. The diaphragm as described in claim 3, wherein a width of the first gap is same to that of the second gap.

6. The diaphragm as described in claim 1, wherein the vibrating member is circular.

7. The diaphragm as described in claim 1, wherein the separating portion is symmetrical with respect to the center of the vibrating member.

8. The diaphragm as described in claim 7, wherein the separating portion is concentric with respect to the center of the vibrating member.

9. A silicon condenser microphone, comprising:
a backplate having a plurality of perforations therethrough;
a diaphragm opposed from the backplate for forming a capacitor, the diaphragm comprising a vibrating member, a plurality of supporting members extending from a periphery of the vibrating member along a direction away from a center of the diaphragm, and a plurality of separating portions each located between two adjacent supporting members;
wherein, at least one of the supporting member defines a first beam, a second beam, and at least one slit between the first and second beams.

10. The silicon condenser microphone as described in claim 9, wherein the slit extending from one end of each supporting member far from the periphery of the vibrating member to another end of the supporting member near the periphery of the vibrating member.

11. A diaphragm, comprising:
a vibrating member;
a plurality of supporting members extending from a periphery of the vibrating member along a direction away from a center of the diaphragm;
a plurality of separating portions each located between two adjacent supporting members;
wherein, each of the supporting members defines an upper surface, a lower surface opposite to the upper surface, and at least one slit drilled from the upper surface completely through the lower surface.

12. The diaphragm as described in claim 11, wherein a first gap is formed between the vibrating member and the separating portions and a second gap is formed between the separating portion and an adjacent supporting member.

13. The diaphragm as described in claim 11, wherein the periphery of the vibrating member is divided into a plurality of equal parts by the supporting members.

14. The diaphragm as described in claim 12, wherein a width of the first gap is same to that of the second gap.

15. The diaphragm as described in claim 11, wherein the vibrating member is circular.

16. The diaphragm as described in claim 11, wherein the separating portion is symmetrical with respect to the center of the vibrating member.

17. The diaphragm as described in claim 16, wherein the separating portion is concentric with respect to the center of the vibrating member.
